(19) United States
(12) Patent Application Publication
(10) Pub. No.: US 2025/0036086 A1
(43) Pub. Date: Jan. 30, 2025

(54) TEMPO DETECTION AND DISPLAY SYSTEM, MUSIC PRACTICE AND MASTERY SYSTEM, MUSICAL AID, PROCESS, AND METHOD OF USE

(71) Applicant: Brian McGuinness, Lanesborough, MA (US)

(72) Inventor: Brian McGuinness, Lanesborough, MA (US)

(21) Appl. No.: 18/783,483

(22) Filed: Jul. 25, 2024

Related U.S. Application Data
(60) Provisional application No. 63/528,762, filed on Jul. 25, 2023.

(51) Int. Cl. G04F 5/02; G09B 15/00; G09G 3/10; G09G 3/14; G10G 7/00; G10H 1/00

(52) U.S. Cl. CPC G04F 5/025; G09B 15/00; G09G 3/10; G09G 3/14; G10G 7/00; G10H 1/0008; G10H 2210/076; G10H 2220/005

(57) ABSTRACT

A tempo detection and display system, a musical practice and mastery system, a musical aid, a disc jockey aid, processes, and method of use are presented. The present disclosure is configured to provide measurements and display these measurements, and in particular display via nixie tubes. The measurements configured of and/or interpreting an external audio signal. Additionally, the system is configured to measure and display dB SPL; decibel of sound pressure level, also referred to as “dB SPL”, “decibel of sound pressure level” or “decibel sound pressure level”. To switch what parameter is being displayed, a 3-state toggle switch; or “toggle switch” or “toggle”, which is located on the main body.

### CROSS-REFERENCE TO RELATED APPLICATIONS

The present application claims priority to the U.S. Provisional Patent Application No. 63/528,762 which was filed on Jul. 25, 2023, which is hereby incorporated by reference herein in its entirety, including any figures, tables, or drawings.

### FIELD OF THE INVENTION

This disclosure relates to a tempo detection and display system, a musical practice and mastery system, a musical aid, a disc jockey aid, processes, and method of use. More specifically, and without limitation, the present disclosure relates to a tempo monitoring hardware and program system for musicians, disc jockeys, and others interested in music and/or detection of patterns and/or rhythms. The present disclosure detects from an environment a tempo and displays that tempo in beats per minute or in other desired expressions such as a playback guide and the like. These and other features are disclosed, as will become further apparent herein.

### BACKGROUND OF THE INVENTION

Musical metronomes are well known in the art. A metronome is a device which produces an audible click. The click is produced at a regular interval. The regular interval can be determined by the user. Typically this regular interval is measured and/or set in beats per minute (BPM). Users, and particularly musicians, utilize a metronome for practice and/or to help the musician keep a particular beat in playing music. In this way, a user can practice and/or utilize a metronome for the purpose of playing music at a particular speed and/or rhythm.

Today, musicians and music students practice keeping time in music by using conventional metronomes. A modern metronome is based on clockwork and/or a pendulum are utilized to time and/or beat and/or produce clicks for such a metronome to keep a steady tempo as the musician plays. Some of the difficulties with using today's metronomes are that they eventually stops and will require rewinding, they becomes annoying and disruptive if the metronome stops halfway through a session, larger metronome devices may be fixed in place,

Other metronomes, such as smaller more portable devices provide a click sound at a time interval. This type of conventional metronome provides a periodic ticking to help the musician keep to tempo. In this case, a user will try to match the ticking and/or clicking of the metronome as the musician plays, listening to the beat determined by the ticking. However, another issue with metronomes is that it requires great skill to use. For example, an audible metronome requires a trained ear. This means a user must learn a new skill just to utilize a device designed to teach. This can be especially challenging for new users or beginners.

Other modern metronomes are completely too quiet altogether, meaning even the best trained musicians can't utilize metronomes for practice and the like. The ticking of such a metronome may be too soft for many different applications and situations, let alone if a small group tried to practice together; or even a large group.

So despite being around for many years, metronomes struggle to be beneficial tools, and may be difficult to learn from and the like. Furthermore, few advancements have been made to metronomes. Thus, there is a long-felt need in the art for a new device which makes practicing music and/or playing music easier. More specifically, and without limitation, there is a long-felt need in the art for a new device which makes practicing music and/or playing music at a consistent and/or intentional tempo easier and more efficient. Furthermore, the present disclosure solves these learning needs and more. For example, current metronomes may be limited to what a user sets the beat at. The present disclosure detects a beat autonomously from an environment and can display that beat, and then also provide a metronome if the user desires; as one example.

The disclosure herein provides these advantages and others as will become clear from the specification and claims provided.

### SUMMARY OF THE INVENTION

A tempo detection and display system, a musical practice and mastery system, a musical aid, a disc jockey aid, processes, and method of use. More specifically, and without limitation, the present disclosure relates to a tempo monitoring hardware and program system for musicians, disc jockeys, and others interested in music and/or detection of patterns and/or rhythms. The present disclosure detects from an environment a tempo and displays that tempo in beats per minute or in other desired expressions such as a playback guide and the like. These and other features are disclosed, as will become further apparent herein. Furthermore, and without limitation, the present disclosure provides a musical system for musicians, music recording studios, audio engineers, recording engineers, music enthusiasts, a combinations thereof, and/or others interested in music and/or detection of patterns.

Thus, it is a primary object of the disclosure to provide a tempo detection and display system, a musical practice and mastery system, a musical aid, a disc jockey aid, processes, and method of use that improves upon the state of the art.

Another object of the disclosure is to provide a tempo detection and display system, a musical practice and mastery system, a musical aid, a disc jockey aid, processes, and method of use that monitors the tempo of an environment.

Yet another object of the disclosure is to provide a tempo detection and display system, a musical practice and mastery system, a musical aid, a disc jockey aid, processes, and method of use that monitors the tempo of an environment for a musician.

Another object of the disclosure is to provide a tempo detection and display system, a musical practice and mastery system, a musical aid, a disc jockey aid, processes, and method of use that monitors the tempo of an environment for a user.

Yet another object of the disclosure is to provide a tempo detection and display system, a musical practice and mastery system, a musical aid, a disc jockey aid, processes, and method of use that detects the tempo of an environment.

Another object of the disclosure is to provide a tempo detection and display system, a musical practice and mastery system, a musical aid, a disc jockey aid, processes, and method of use that detects music in an environment.

Yet another object of the disclosure is to provide a tempo detection and display system, a musical practice and mastery system, a musical aid, a disc jockey aid, processes, and method of use that detects music in an environment and displays the beats per minute of the music.

Another object of the disclosure is to provide a tempo detection and display system, a musical practice and mastery system, a musical aid, a disc jockey aid, processes, and method of use that displays the beats per minute of an environment on a nixie tube display.

Yet another object of the disclosure is to provide a tempo detection and display system, a musical practice and mastery system, a musical aid, a disc jockey aid, processes, and method of use that is easy to use.

Another object of the disclosure is to provide a tempo detection and display system, a musical practice and mastery system, a musical aid, a disc jockey aid, processes, and method of use that delivers high quality results.

Yet another object of the disclosure is to provide a tempo detection and display system, a musical practice and mastery system, a musical aid, a disc jockey aid, processes, and method of use that is easy to access.

Another object of the disclosure is to provide a tempo detection and display system, a musical practice and mastery system, a musical aid, a disc jockey aid, processes, and method of use that is easy to understand.

Yet another object of the disclosure is to provide a tempo detection and display system, a musical practice and mastery system, a musical aid, a disc jockey aid, processes, and method of use that is robust.

Another object of the disclosure is to provide a tempo detection and display system, a musical practice and mastery system, a musical aid, a disc jockey aid, processes, and method of use that can detect music from any genre.

Yet another object of the disclosure is to provide a tempo detection and display system, a musical practice and mastery system, a musical aid, a disc jockey aid, processes, and method of use that can display a constant or near constant tempo.

Another object of the disclosure is to provide a tempo detection and display system, a musical practice and mastery system, a musical aid, a disc jockey aid, processes, and method of use that updates tempo displays.

Yet another object of the disclosure is to provide a tempo detection and display system, a musical practice and mastery system, a musical aid, a disc jockey aid, processes, and method of use that utilizes strong impulses.

Another object of the disclosure is to provide a tempo detection and display system, a musical practice and mastery system, a musical aid, a disc jockey aid, processes, and method of use that can be set with rules to focus on particular impulses as more influential over other impulses (drums, accentuate rhythm instruments, and more).

Yet another object of the disclosure is to provide a tempo detection and display system, a musical practice and mastery system, a musical aid, a disc jockey aid, processes, and method of use that is accurate.

Another object of the disclosure is to provide a tempo detection and display system, a musical practice and mastery system, a musical aid, a disc jockey aid, processes, and method of use that provides an objective tempo reference.

Yet another object of the disclosure is to provide a tempo detection and display system, a musical practice and mastery system, a musical aid, a disc jockey aid, processes, and method of use that provides tempo adjustments.

Another object of the disclosure is to provide a tempo detection and display system, a musical practice and mastery system, a musical aid, a disc jockey aid, processes, and method of use that enhances musical expression.

Yet another object of the disclosure is to provide a tempo detection and display system, a musical practice and mastery system, a musical aid, a disc jockey aid, processes, and method of use that enhances musical performance.

Another object of the disclosure is to provide a tempo detection and display system, a musical practice and mastery system, a musical aid, a disc jockey aid, processes, and method of use that improves timing.

Yet another object of the disclosure is to provide a tempo detection and display system, a musical practice and mastery system, a musical aid, a disc jockey aid, processes, and method of use that provides flexibility in use and functionality.

Another object of the disclosure is to provide a tempo detection and display system, a musical practice and mastery system, a musical aid, a disc jockey aid, processes, and method of use that provides a display.

Yet another object of the disclosure is to provide a tempo detection and display system, a musical practice and mastery system, a musical aid, a disc jockey aid, processes, and method of use that provides an external device.

Another object of the disclosure is to provide a tempo detection and display system, a musical practice and mastery system, a musical aid, a disc jockey aid, processes, and method of use that utilizes a plurality of environmental sensors.

Yet another object of the disclosure is to provide a tempo detection and display system, a musical practice and mastery system, a musical aid, a disc jockey aid, processes, and method of use that utilizes a microphone.

Another object of the disclosure is to provide a tempo detection and display system, a musical practice and mastery system, a musical aid, a disc jockey aid, processes, and method of use that can run autonomously, making adjustments as determined by a predetermined set of rules.

Yet another object of the disclosure is to provide a tempo detection and display system, a musical practice and mastery system, a musical aid, a disc jockey aid, processes, and method of use that tracks historical data.

Another object of the disclosure is to provide a tempo detection and display system, a musical practice and mastery system, a musical aid, a disc jockey aid, processes, and method of use that provides alerts (such as when a tempo increases and/or decreases).

Yet another object of the disclosure is to provide a tempo detection and display system, a musical practice and mastery system, a musical aid, a disc jockey aid, processes, and method of use that can be used with various digital platforms.

Another object of the disclosure is to provide a tempo detection and display system, a musical practice and mastery system, a musical aid, a disc jockey aid, processes, and method of use that can link to a smart device.

Yet another object of the disclosure is to provide a tempo detection and display system, a musical practice and mastery system, a musical aid, a disc jockey aid, processes, and method of use that provides a user interface.

Another object of the disclosure is to provide a tempo detection and display system, a musical practice and mastery system, a musical aid, a disc jockey aid, processes, and method of use that is quick and efficient to set up and use.

Yet another object of the disclosure is to provide a tempo detection and display system, a musical practice and mastery system, a musical aid, a disc jockey aid, processes, and method of use that is easy to program to various predetermined rule sets.

Another object of the disclosure is to provide a tempo detection and display system, a musical practice and mastery system, a musical aid, a disc jockey aid, processes, and method of use that saves time for a user.

These and other objects, features, or advantages of the present disclosure will become apparent from the specification and claims.

### BRIEF DESCRIPTION OF DRAWINGS

The drawings accompanying and forming part of this specification are included to depict certain aspects of the disclosure.

FIG. 1 is a diagram illustrating various primary components of the tempo detection and display system; the view showing an environment and different environmental interactions and stimuli.

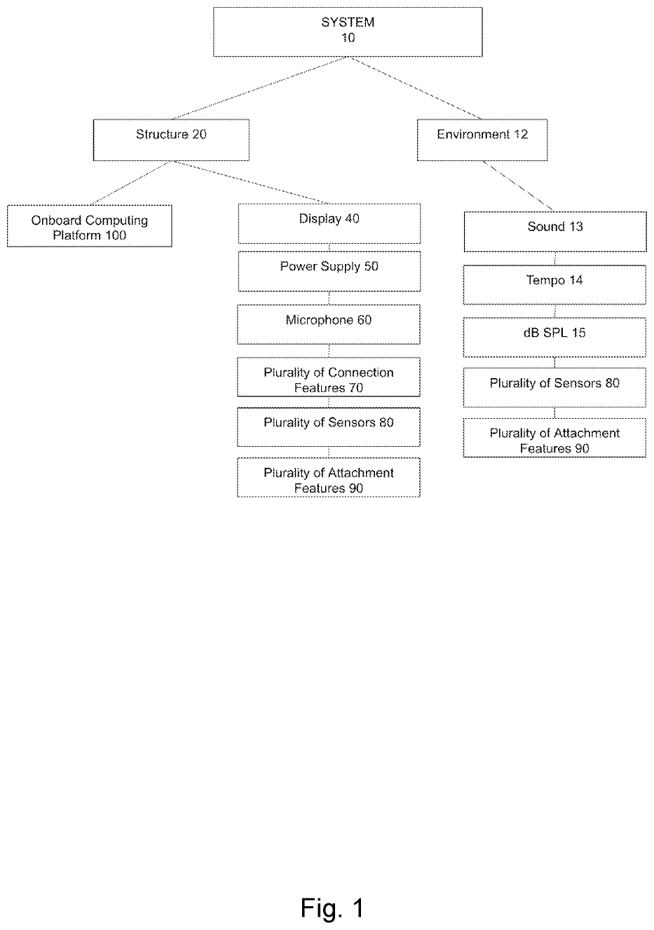

FIG. 2 is a diagram illustrating various primary components of the tempo detection and display system; the diagram illustrates the interactions of various components of the system.

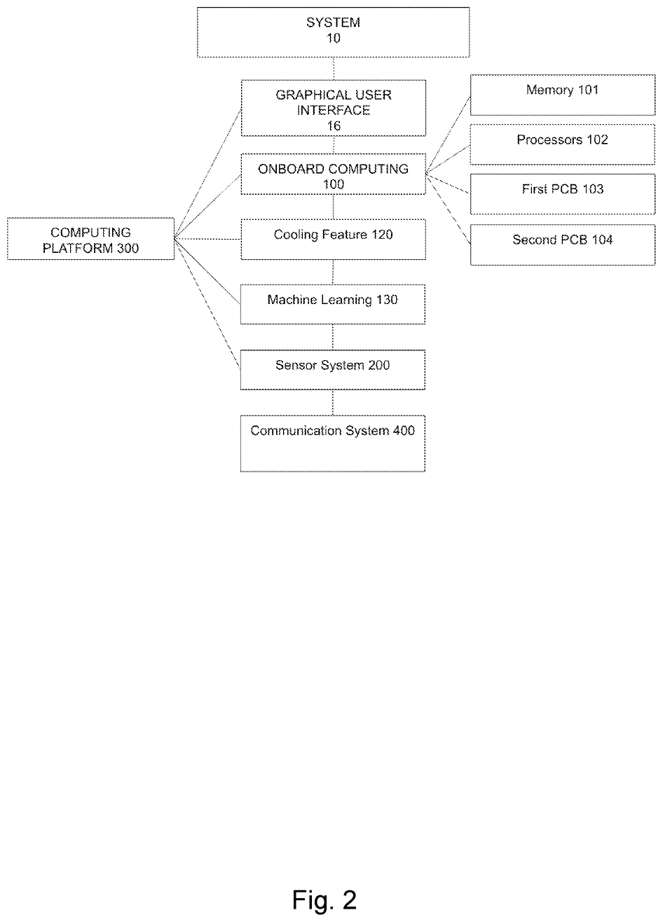

FIG. 3 is a diagram illustrating various primary components of the tempo detection and display system; the view showing various components of the main body.

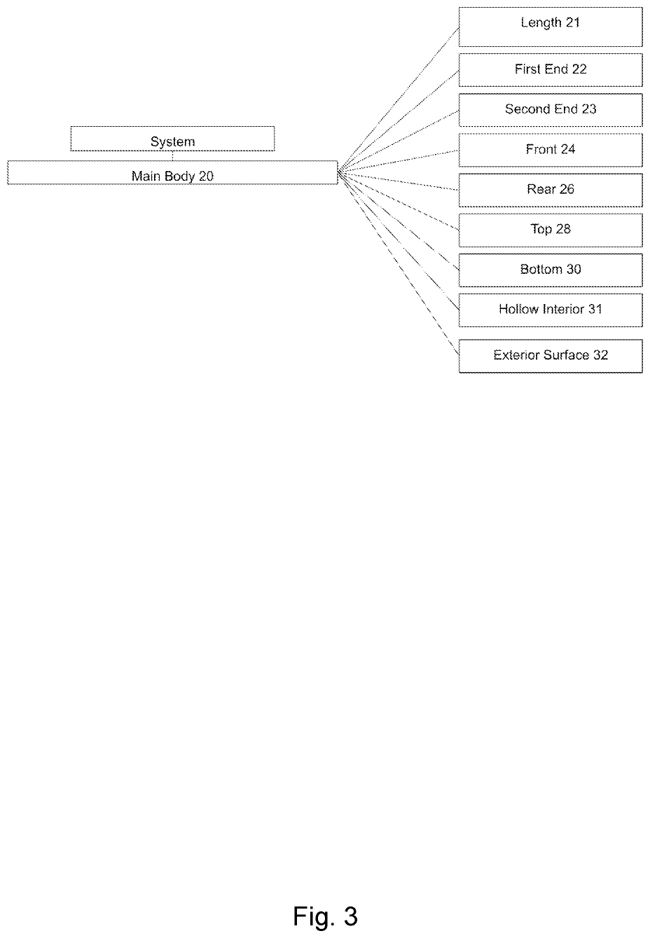

FIG. 4 is a diagram illustrating various primary components of the tempo detection and display system; the view showing various components of the display system.

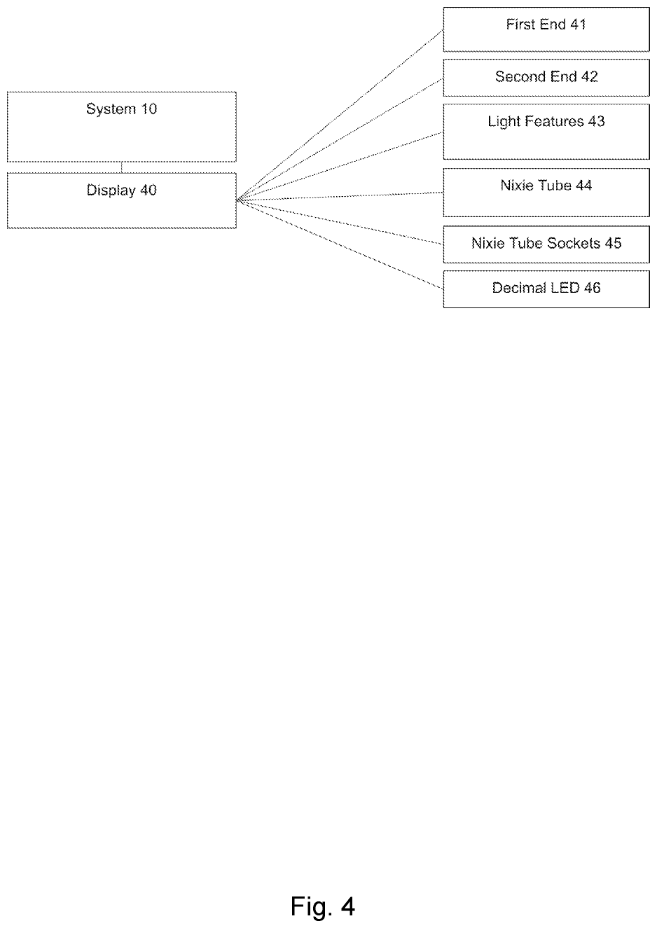

FIG. 5 is a diagram illustrating various primary components of the tempo detection and display system; the diagram illustrates sound and tempo interactions.

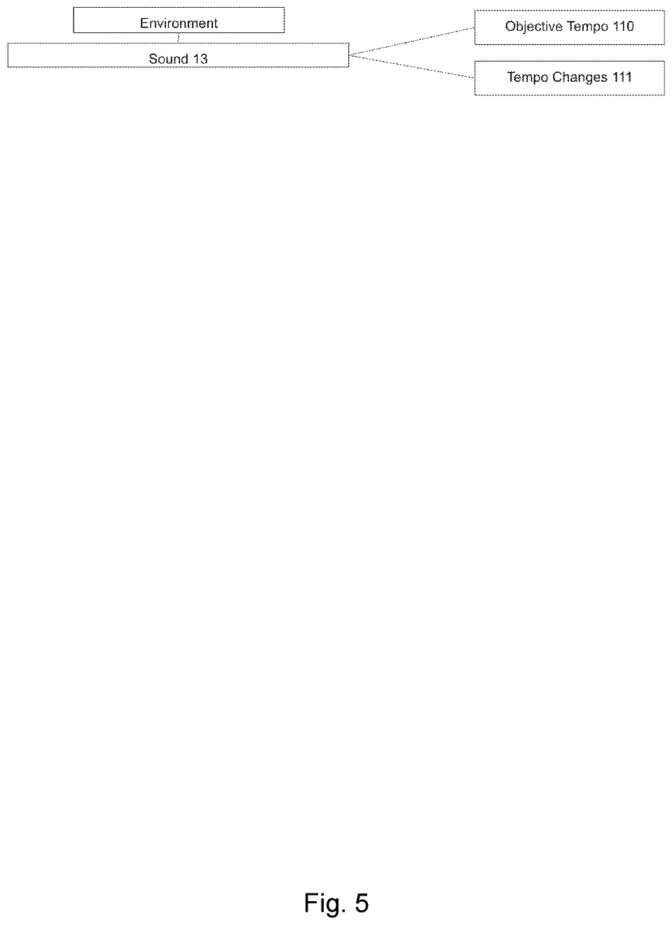

FIG. 6 is a diagram illustrating various primary components of the tempo detection and display system; the diagram illustrates an embodiment with a 3-toggle switch.

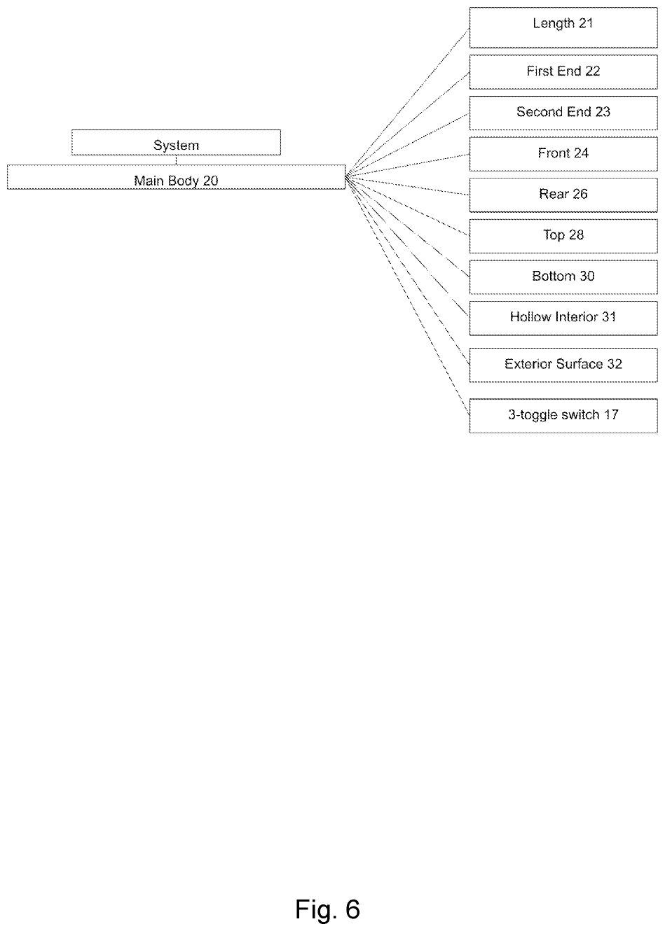

FIG. 7 is a top, perspective view of the dB SPL and tempo display system; the view showing the display system extending from a first end to a second end with a display on the front; the view showing the display having four nixie tubes.

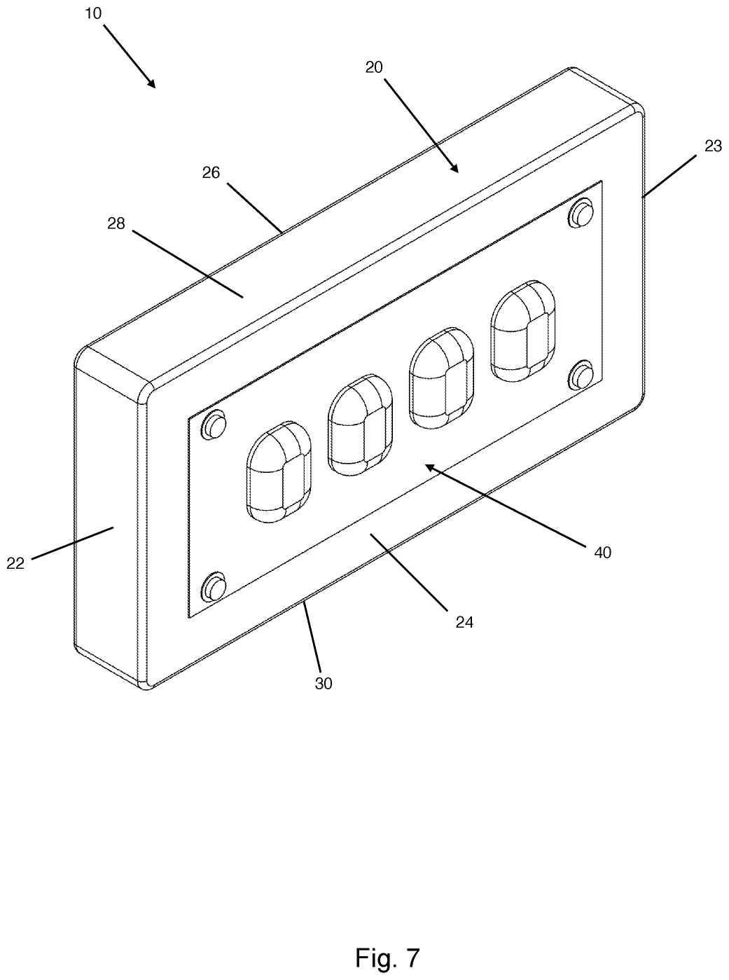

FIG. 8 is a front view of the dB SPL and tempo display system; the view showing the display system extending from a first end to a second end with a display on the front; the view showing the display having four nixie tubes.

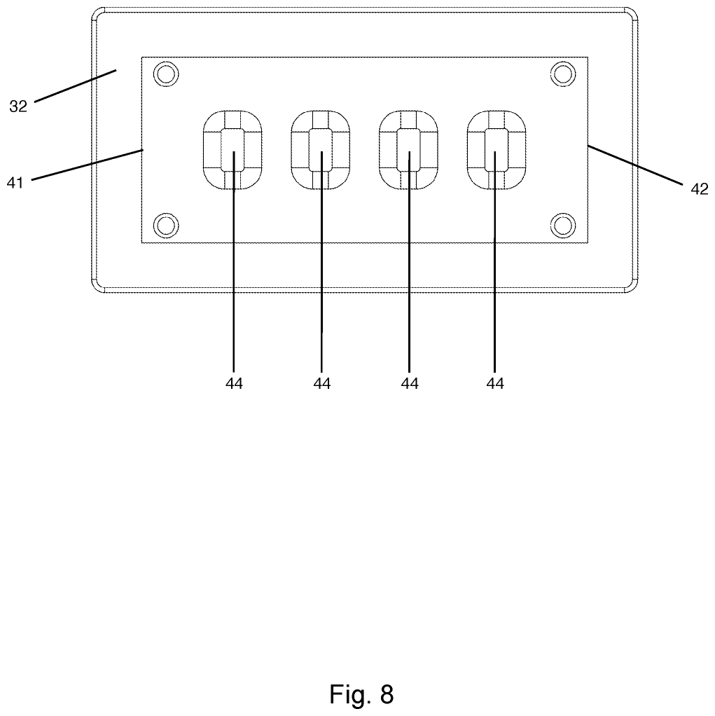

FIG. 9 is a rear view of the dB SPL and tempo display system; the view showing the display system extending from a first end to a second end with a display on the front; the view showing the display having four nixie tubes.

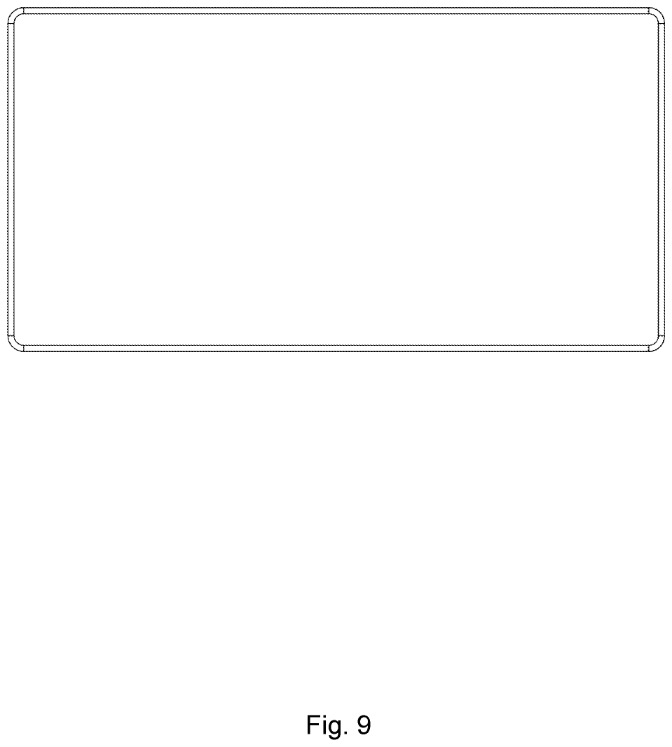

FIG. 10 is a side view of the dB SPL and tempo display system; the view showing the display system extending from a first end to a second end with a display on the front; the view showing the display having four nixie tubes.

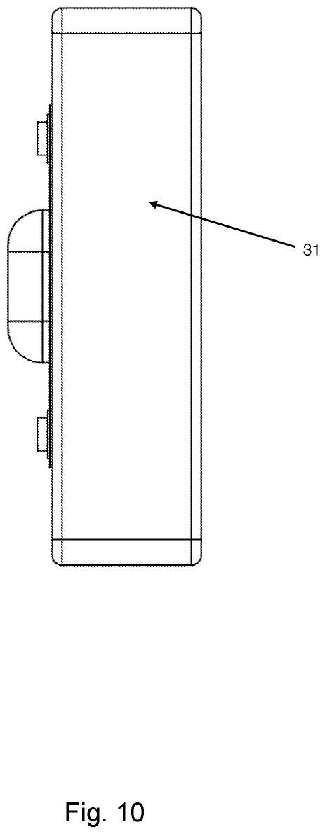

FIG. 11 is a bottom, perspective view of the dB SPL and tempo display system; the view showing the display system extending from a first end to a second end with a display on the front; the view showing the display having four nixie tubes.

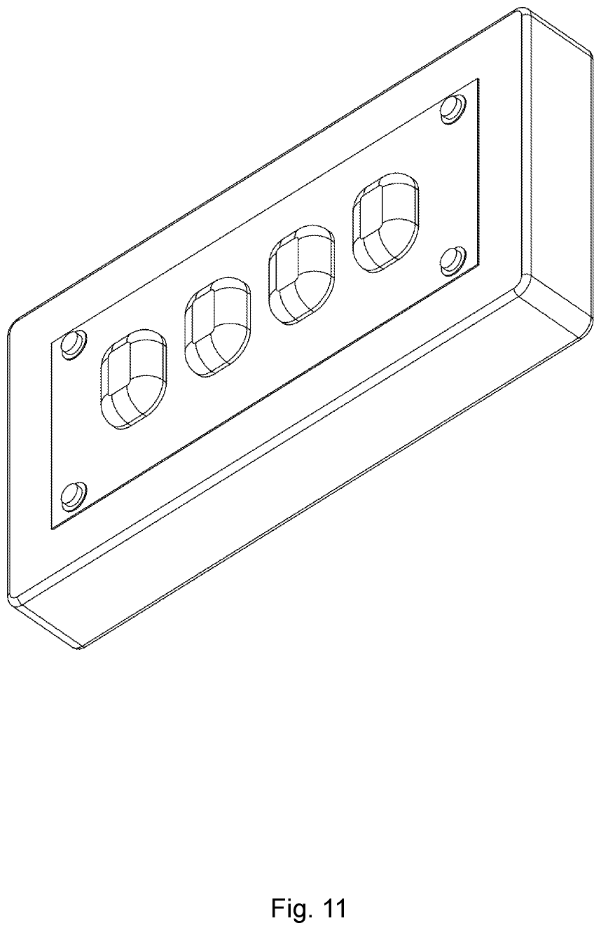

FIG. 12 is a diagram illustrating various primary components of the tempo detection and display system; the diagram showing a power supply and power delivery illustration.

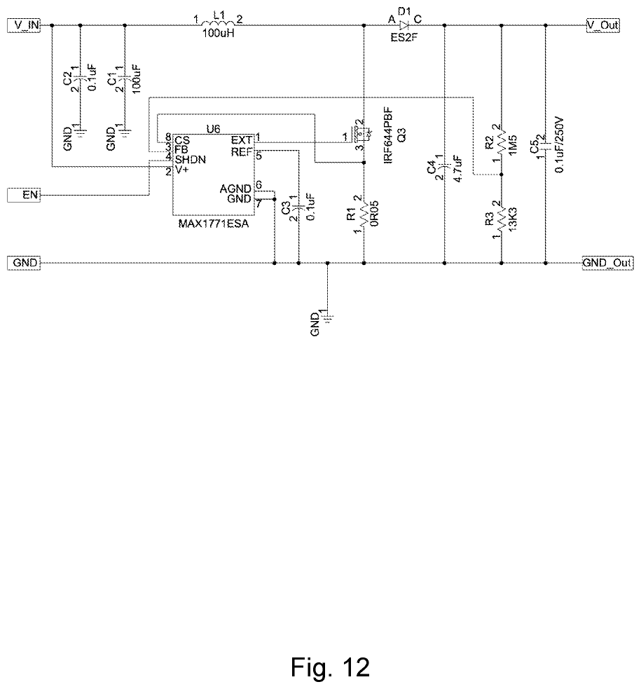

FIG. 13 is a diagram illustrating various primary components of the tempo detection and display system; the diagram illustrates various components of the system and the connection of these components.

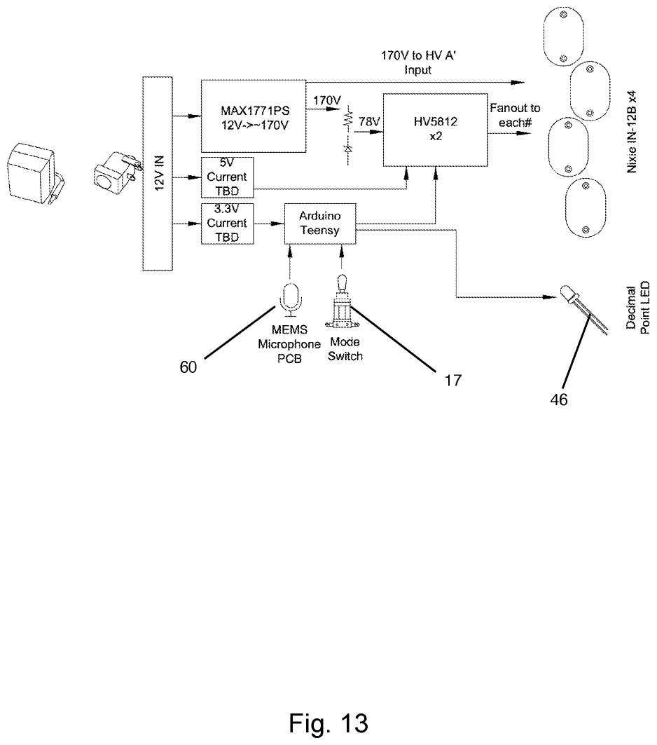

### DESCRIPTION

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium.

Any combination of one or more computer-usable or computer-readable media may be utilized. For example, a computer-readable medium may include one or more of a portable computer removable drive, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code, or virtual code, or framework code suitable for the disclosure herein, or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“Saas”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

### System:

With reference to the figures, a tempo detection and display system, a musical practice and mastery system, a musical aid, a disc jockey aid, processes, and method of use 10 are presented. Tempo detection and display system 10 (hereafter referred to as “tempo system”, “tempo display system”, “tempo detection system”, “tempo monitoring system”, “dB SPL and tempo display system”, or simply “system”) is formed of any suitable size, shape and design.

In the arrangement shown, as one example, in addition to other features and functionalities disclosed herein, system 10 is configured to provide measurements and display these measurements. The measurements configured of and/or interpreting an external audio signal 14. Additionally, system 10 is configured to measure and display dB SPL 15 (decibel of sound pressure level) (also referred to as “dB SPL”, “decibel of sound pressure level” or “decibel sound pressure level”).

To switch what parameter is being displayed, a 3-state toggle switch 17 (or “toggle switch” or “toggle”) is located on the main body. In one arrangement the toggle switch 17 is located on the back of the main body. The 3 states of the toggle switch are: OFF, sB PCL, and BPM. In this way, the device can be switched between these three modes of off, or not displaying, displaying sB PCL 15, or displaying BPM 14 (beats per minute, or “tempo” 14). Said another way, system 10 detects and interprets an incoming audio signal 14, determines the volume in decibels, outputting the value via a nixie tube 44 (further described herein).

In the arrangement shown, as one example, tempo display system 10 is configured to detect a stimuli (such as music) in an environment through a microphone or the like, process the stimuli, determine the beats per minute of the music or an accentuated rhythm instrument (such as drums), and display the beats per minute detected.

In one arrangement, as one example, the beats per minute is displayed to a user. In another example, the beats per minute are utilized for other purposes such as providing alerts to a user based on a set of predetermined rules. For example, the system may caution a user to slow down or speed up based on the beats per minute detected such that a user can stay within a desired goal. These notifications or alerts can be flashing lights or voice commands, and the like.

In the arrangement shown, as one example, tempo display system 10 may comprise remote servers, databases, application servers, application databases, musical databases, mobile applications, and/or computers; all of which in continuity or as separate acts fulfill the functions disclosed herein. Tempo monitoring system 10 also includes, in the embodiment(s) depicted, a user 11, an environment 12, a stimuli and/or sound 13, a tempo 14 a graphical user interface 16, a structure 20 (or main body), a display 40, a power supply 50, a microphone 60, a plurality of connection features 70, a plurality of sensors 80, a plurality of attachment features 90, an onboard computing platform 100, an objective tempo 110, a sensor system 200, a computing system 300, a communication and/or control system 400, an application server, and a mobile computing application, among other components, features, and functions.

### User (or Plurality Thereof):

In the arrangement shown, as one example, system 10 may include a user 11. User 11 may be any user interacting with or utilizing the system 10. This may include viewing, controlling, analyzing, manipulating, and/or interacting with system 10. User 11 is not limited to a single user but may be a plurality of users. In one example, a user may be a practicing musician or student learning an instrument. In another example, a user 11 may be a band performing a plurality of instruments, and the like.

### Graphical User Interface:

In the arrangement shown, as one example, system 10 may include a graphical user interface 16. Graphical user interface 16 is formed of any suitable size shape and design and is configured to allow a user to view interact with, manipulate, and visually access system data and information, information related thereto, and/or view various data for various environments and/or add information to system and/or environment and/or change the settings of the sensors and/or change the settings of operation. For example, a user may change a desired beat per minute for which to stay at with upper and lower limits via the graphical user interface.

Display of Graphical User Interface: Graphical user interface 12 may include a display, which is configured to show and display information, including data, for review and interpretation by a user or plurality of users, or a plurality of users interacting with one another. The display of the graphical user interface refers to the display for interacting with and/or manipulating the system, NOT the display for displaying the beats per minute of an environment (which is further described herein).

### Structure (Main Body):

In the arrangement shown, as one example, system 10 includes a structure 20 or main body. Main body 20 is formed of any suitable size, shape, and design, and is configured to act as the primary display system and physical device which a user can place in an environment and interact with, with ease.

In the arrangement shown, as one example, main body 20 is generally rectangular and/or box like in shape extending a length 21 from a first end 22 to a second end 23 having a front side 24 (with a display of the main body) and a rear side 26, a top 28, a bottom 30, a hollow interior-housing a plurality of processing components and the like—and an exterior surface 32—housing a plurality of connection features, attachment features and the like.

### Display (of Main Body):

In the arrangement shown, as one example, system 10 includes a display 40. In the arrangement shown, as one example, display 40 is formed of a nixie tube and displays the beats per minute (as detected by a microphone of an environment). The display 40 is on the front side of the main body in the example shown.

In the arrangement shown, as one example, the display is formed of a nixie tube. However, other display options are hereby contemplated for use. This could be an analog like number display of printed numbers. Display may also be a digital number display, other types of displays such as an interactive and/or smart touch screen, and the like.

### Power Supply:

In the arrangement shown, as one example, system 10 includes a power supply 50. In the arrangement shown, as one example, power supply 50 is formed of a power cord which plugs into an outlet. However, other power supplies are also hereby contemplated for use.

Alternative power supplies contemplated for use include, but are not limited to, a battery, a plurality of batteries, a rechargeable battery, a plurality of rechargeable batteries, a solar power supply with a small integrated panel and circuit, and other means of providing power to the system.

In an alternative arrangement, as one example, system 10 includes a barrel style jack for power input.

### Microphone:

In the arrangement shown, as one example, system 10 includes a microphone 60. Microphone 60 is formed of any suitable size, shape, and design, and is configured to detect the music and/or sounds and/or vibrations of an environment.

In one example, the microphone is a MEMS-based PDM microphone. In this example, the microphone is located on the front of the main body. However, other microphone locations are hereby contemplated for use. This may include internally located, located by wired attachment to the main body. Similarly, this may include a plurality of microphones located in various locations.

### Sensor Systems:

In the arrangement shown, as one example, system 10 includes a sensor system, in addition to and/or in replacement of a microphone. Sensor system is formed of any suitable size, shape, and design and may include one or more sensors and/or one or more sensing technologies. In the arrangement shown, as one example, sensor system is configured to detect and communicate information related to an environment, primarily associated with sounds and/or vibration detection within an environment as well as the surroundings and/or environment of a room of system 10 and the like.

### Other Sensors:

In addition to the microphone and/or sound detection sensors, video and/or motion sensors may be utilized to directly detect strumming and/or movement of a user in an environment to determine how fast a user is playing an instrument, strumming, and/or a combination thereof to aid in teaching and determinations.

### Attachment and Connection Features:

In the arrangement shown, as one example, system 10 includes a plurality of connections features such as programming plugs and the like which can be found on the surface of the main body 20. Similarly, system 10 may also include a plurality of attachment features for easily placing the system in a location where many can see and observe. For example, the main body may be hangable by a small strap or hook and loop so as to place in an easily viewable location for a user, a band, an orchestra and the like.

Programming port: In one arrangement, system 10 includes a programming port 71. In the arrangement shown, as one example, programming port is configured as an internal micro usb connector with external access for programming, adjustments, and connecting to outside sources for use.

### dB SPL Feature:

In the arrangement shown, as one example, system 10 includes a dB SPL feature (also referred to as “SPL feature”). SPL feature is formed of any suitable size, shape, and design and is configured to measure the volume of an environment. In one embodiment, the SPL feature is formed of a button. A user can press this button to alternate and/or simultaneously display both the beats per minute of an environment and the volume of an environment.

Said another way, the SPL feature includes a sound pressure level or volume detection and display system for sensing the volume of the noise in an environment and displaying this volume. The volume or noise level and/or sound pressure level may displayed in decibels or other units. In this way, the decibel level of an environment can be used to aid musicians and the like.

While use by a musician is hereby contemplated for use. Other users may also utilize the dB SPL feature such as an audiologist, sound engineer, and the like for detection of noise levels in an environment. In this way, a user may be able to determine safe volume levels and make adjustments as needed, such as setting up for live music, sound checks, compliance of neighborhood noise levels, volume level desires, and the like.

### Toggle Switch:

In one arrangement, to switch what parameter is being displayed, a 3-state toggle switch 17 (or “toggle switch” or “toggle”) is located on the main body. In one arrangement the toggle switch 17 is located on the back of the main body. The 3 states of the toggle switch are: OFF, sB PCL, and BPM. In this way, the device can be switched between these three modes of off, or not displaying, displaying sB PCL 15, or displaying BPM 14 (beats per minute, or “tempo” 14). Said another way, system 10 detects and interprets an incoming audio signal 14, determines the volume in decibels, outputting the value via a nixie tube 44 (further described herein).

### Computing Platform:

In the arrangement shown, as one example, system 10 includes a computing platform 300 (or “computer”, or “computer platform”). Computing platform 300 is formed of any suitable size, shape, and design and is configured to provide computing support, power, and computing processing for both onboard computing functionality as well as communication for off-board or server computing functionality. In this way, an onboard computing system, among other components and features on top of the platform.

In the arrangement shown, as one example, system 10 includes a computer 300. Computer 300 is formed of any suitable size, shape, and design and is configured to provide for the main off-board computing processing and implementation of computer handling of data from data gathering performed.

### Onboard Computing System:

In one arrangement, as is shown, system 10 includes an onboard computing system (or “onboard computing device”). Onboarding computing system is formed of any suitable size, shape, and design and configured to handle onboard computing operations, as are necessary for the operation of system 10. Onboarding computing device is connected with electronic network and/or database and/or server or cloud via communication means, bluetooth communication, bluetooth low energy chip (BLE onboard), and may include a processor, a memory, a microcontroller, a printed circuit board, a microprocessor, a receiver/transceiver, may include at least one antenna, and a global positioning system, among other components.

Printed Circuit Board: In the arrangement shown, as one example, system 10 may include a printed circuit board (“PCB”). PCB is formed of any suitable size, shape and design and is configured to facilitate carrying and/or holding other components and/or parts necessary to carry out various computation and/or related functions of system 10. PCB, as one example, might be a surface mounted PCB or a through-hole PCB. PCB, as one example, is green and facilitates connecting the components and/or parts of system 10 by the use of traces and or vias. Traces are formed of any suitable size, shape and design and are configured as lines electrically connecting the components and/or parts of system 10. Vias are formed of any suitable size, shape and design and are configured as holes that connect layers of traces together. Generally, as in shown, traces and vias are soldered to connect the components and/or parts to the PCB.

Microprocessor: Microprocessor is any computing device that receives and processes information and outputs commands according to instructions stored in memory. Memory is any form of information storage such as flash memory, RAM memory, a hard drive, or any other form of memory. Memory may be included as a part of or operably connected to a microprocessor. A receiver/transceiver is connected to a microprocessor. A receiver is used if one way communication is utilized, whereas a transceiver is used if two-way communication is utilized (hereinafter “transceiver”). Receiver/transceiver is connected with an antenna, such as a monopole antenna, a loop antenna, a fractal antenna, or any other form of an antenna. Antenna receives wireless signals from any other device, transmits these signals to receiver/transceiver which processes these signals and then transmits these processed signals to microprocessor which processes these signals according to instructions stored in memory. In one arrangement, system 10 re-transmits operating commands signals through receiver/transceiver so as to similarly control over-the-air communication. Communication is any form of wireless signals, or wired signals, through the air, such as a conventional remote signal, a cell phone, a wireless device, an internet connected device, a hard-wired device, or any other device capable of transmitting remote control signals.

Memory: In the arrangement shown, as one example, system 10 includes a memory. Memory may be formed of any suitable size, shape and design and is configured to facilitate selective storage and retrieval of data (including data) in association with computing devices, processors, software and interactive user display. Memory may be a single component, such as a single chip or drive or other memory device, or alternatively memory may be formed of a plurality of memory or storage components that are connected to one another that may be co-located or located at different geographic locations.

### Remote Computing System:

In one arrangement, as is shown, system 10 includes a remote computing system (or “remote computing device”). Remote computing device is formed of any suitable size, shape, and design and configured to handle onboard computing operations, as are necessary for the operation of system 10. Remote computing device is connected with electronic network and/or database and/or server or cloud via communication means and includes a processor, a memory, a microcontroller, a printed circuit board, a microprocessor, a receiver/transceiver, may include at least one antenna, a power supply, and a communications system, among other components.

### Application Server:

In the arrangement shown, as one example, system 10 may comprise remote servers, databases, and/or computers that fulfill the functions disclosed and described herein. In the embodiment depicted, system 10 comprises an application server 600. Application server 600 comprises one or more computer systems adapted to transmit and receive data regarding selected datasets related to various users and/or datasets related to multiple users. Application server 600 is adapted to query databases, and may utilize unique identification codes, to retrieve information and associated information related to system 10.

Application server 600 may transmit data and/or related documents with respect to a system 10. Application server 600 is also adapted to query a database. Additionally, application server 600 may communicate with a cloud computing system or a mobile application, which can also be adapted to present the data in a form conducive to being viewed on a mobile device and/or handheld device.

As one of ordinary skills in the art may understand, application server 600, database, and other databases mentioned herein may be implemented in one or more servers. Furthermore, each may be on multiple servers to increase system efficiency, especially when handling large data gathering, following extended guidelines, extended ranges, ranges discussed herein. Additionally, multiple servers may have mirrored data to prevent data loss in case of disk failure and/or to decrease access and response times for database queries. In alternative embodiments, application server 600, and other database procedures may be carried out on computer-readable instructions and data stored on the customer's mobile computing device.

### Alternative Embodiment:

In another arrangement, and as another example, system 10 includes a main body 20 extending a length 21 from a first end 22 to a second end 23 having a front 24, a rear 26, a top 28, a bottom 30, and a hollow interior 31 (or interior cavity 31) and exterior surface 32 forming an approximate three-dimensional rectangle.

System 10 includes a display 40 located on the front of the main body, the display having a first end 41 (to the left when looking at the front) and a second end (to the right when looking at the front) featuring four nixie tubes 44.

First PCB: In one example, system 10 includes a first PCB 103 for nixie tube and power control. This includes nixie tube sockets 45, decimal led 46, high voltage nixie tube supply, a power supply for the micro controller and all logic-based signals, an additional power supply, shift registers to drive nixie state, ribbon cable port as a board-a board connector carrying power, GND, shift register signal data, shift register signal CLK, and a 2-wire connectorized power input from female barrel jack.

Second PCB: In one example, system 10 includes a second PCB 104 for logic control. The second PCB 104 includes a side mounted internally and includes socketed microcontroller—located such that the USB port is accessible from the back of the product, a JST-SH port for MEMS PDM microphone input, a 2 wire JST style power for Switchcraft toggle input (3 states), and a ribbon cable port as board connector.

LED Decimal Point: In one example, system 10 includes a single LED 46 (light emitting diode) configured to provide a decimal point between nixie digits. In one arrangement, the decimal LED is located between nixie digits three and four. Said another way, this LED decimal is located between the third and fourth digits from the left to the right on the front of the main body.

Cooling: In one arrangement, system 10 includes a cooling feature 120. Cooling feature 120 or “cool air exchanger” or “exchanger” is formed of slats which work for passive cooling providing heat transfer through passive air movement. Furthermore, in another example, a fan is included and configured to provide active cooling.

Machine Learning: In one example, system 10 includes a plurality of algorithms and machine learning 130 among other functionality.

Internal Weight: In one example, system 10 includes internal weight. In this way, weight is added to the interior, and in one example, the bottom center. In this way, additional weight can provide a look and feel which is preferable. Furthermore, the additional weight provides a center of gravity which is low and prevents tipping.

### In Operation:

In another embodiment, and as another example of operation settings, the decibel SPL mode displays the amplitude in decibels.

In another embodiment, system 10 connects to a digital interface, audio interfaces, digital audio workstations, a combination thereof, and the like.

In one operation, system 10 may be connected to other devices via wifi, bluetooth, and other communication protocols.

In addition to the above identified features, options, controls, and components, system 10 may also include other features and functionalities, among other options, controls, and components.

1. A tempo detection and display system, comprising:
a main body;
the main body extending a length from a first end to a second end;
the main body having a front side, a rear side, a top, and a bottom;
the main body having a hollow interior and an exterior surface;
a display;
the display extending a length from a first end to a second end;
a power supply;
a microphone;
a 3-state toggle switch;
the 3-state toggle switch having an off position;
the 3-state toggle switch having a dB SPL position;
the 3-state toggle switch having a tempo position;
an environment;
the environment having a dB SPL;
a sound;
the sound having a tempo;
wherein the microphone detects the environment and sounds in the environment;
wherein the onboard computing platform processes the environment and sounds in the environment detected by the microphone.

2. The system of claim 1, further comprising:
a plurality of algorithms.

3. The system of claim 1, further comprising:
a communications system;
wherein the communications system includes an antenna for sending and receiving signals.

4. The system of claim 1, further comprising:
a cooling feature.

5. The system of claim 1, further comprising:
an onboard computing platform;
the onboard computing platform having a memory;
the onboard computing platform having a processor;
the onboard computing platform having a first PCB;
the onboard computing platform having a second PCB.

6. The system of claim 1, further comprising:
a plurality of connection features.

7. The system of claim 1, further comprising:
the display having a plurality of light features.

8. The system of claim 1, further comprising:
the display having a plurality of nixie tubes.

9. The system of claim 1, further comprising:
the display having a plurality of nixie tubes;
the display having a decimal LED.

10. The system of claim 1, further comprising:
a programming port.

11. The system of claim 1, further comprising:
a plurality of attachment features.

12. The system of claim 1, further comprising:
a sensory system;
the sensor system having a plurality of sensors.

13. The system of claim 1, further comprising:
the display having a plurality of nixie tubes;
wherein the dB SPL of the sounds in the environment is displayed on the display of the main body when the 3-state toggle switch is in the dB SPL position; wherein the dB SPL is displayed in numbers on the nixie tubes;
wherein the tempo of the sounds of the environment is displayed on the display of the main body when the 3-state toggle switch is in the tempo position; wherein the tempo is displayed in numbers on the nixie tubes.

14. The system of claim 1, further comprising:
the display having a plurality of nixie tubes;
wherein the dB SPL of the sounds in the environment is displayed on the display of the main body when the 3-state toggle switch is in the dB SPL position; wherein the dB SPL is displayed in numbers on the nixie tubes;
wherein the tempo of the sounds of the environment is displayed on the display of the main body when the 3-state toggle switch is in the tempo position; wherein the tempo is displayed in numbers on the nixie tubes;
wherein the decimal LED provides a decimal point for a number being displayed on the display.

15. The system of claim 1, further comprising:
wherein the dB SPL of the sounds in the environment is displayed on the display of the main body when the 3-state toggle switch is in the dB SPL position;
wherein the tempo of the sounds of the environment is displayed on the display of the main body when the 3-state toggle switch is in the tempo position.

16. The system of claim 1, further comprising:
wherein the dB SPL of the sounds in the environment is displayed on the display of the main body when the 3-state toggle switch is in the dB SPL position;
wherein the tempo of the sounds of the environment is displayed on the display of the main body when the 3-state toggle switch is in the tempo position;
wherein the dB SPL and the tempo are displayed in numbers on the nixie tubes;
wherein the decimal LED provides a decimal point for a number being displayed on the display.

17. A dB SPL detection and display system, comprising:
a main body;
the main body extending a length from a first end to a second end;
the main body having a front side, a rear side, a top, and a bottom;
the main body having a hollow interior and an exterior surface;
a display;
the display extending a length from a first end to a second end;
the display having a plurality of light features;
the display having a plurality of nixie tubes;
the display having a decimal LED:
a power supply;
a microphone;
a toggle switch;
an environment;
the environment having a dB SPL;
a sound;
the sound having a tempo;
wherein the microphone detects the environment and sounds in the environment;
wherein the onboard computing platform processes the environment and sounds in the environment detected by the microphone;
wherein both the dB SPL of the sounds in the environment is displayed on the display and the tempo of the sounds of the environment is displayed on the display when the toggle switch is in the dB SPL position and the tempo display;
wherein the dB SPL and the tempo are displayed in numbers on the nixie tubes.

18. The system of claim 17, further comprising:
a plurality of algorithms;
a computing platform;
a communications system.

19. The system of claim 17, further comprising:
a plurality of connection features;
a programming port;
a sensory system;
the sensor system having a plurality of sensors;
a plurality of attachment features;
an onboard computing platform;
the onboard computing platform having a memory;
the onboard computing platform having a processor;
the onboard computing platform having a first PCB;
the onboard computing platform having a second PCB;
a cooling feature.

20. A method of keeping track of environmental stimuli, comprising the steps:
placing the main body in an environment, the main body comprising:
a main body;
the main body extending a length from a first end to a second end;
the main body having a front side, a rear side, a top, and a bottom;
the main body having a hollow interior and an exterior surface;
a display;
the display extending a length from a first end to a second end;
a power supply;
a microphone;
a 3-state toggle switch;
the 3-state toggle switch having an off position;
the 3-state toggle switch having a dB SPL position;
the 3-state toggle switch having a tempo position;
the environment;
the environment having a dB SPL;
a sound;
the sound having a tempo;
wherein the microphone detects the environment and sounds in the environment;
wherein the onboard computing platform processes the environment and sounds in the environment detected by the microphone;
activating the 3-state toggle switch; wherein activating is switching to one of several on positions;
processing the sound of the environment; wherein processing is determining through an onboard computing system what the dB SPL and tempo are of the environment;
displaying both the dB SPL of the sounds in the environment is displayed on the display and the tempo of the sounds of the environment is displayed on the display when the toggle switch is in the dB SPL position and the tempo display; wherein the dB SPL and the tempo are displayed in numbers on the nixie tubes.
